(19) United States
(12) Patent Application Publication
(10) Pub. No.: US 2026/0351215 A1
(43) Pub. Date: Nov. 5, 2026

(54) DISPLAY DEVICE AND DRIVING METHOD THEREOF

(71) Applicant: Guangzhou China Star Optoelectronics Semiconductor Display Technology Co., LTd., Guangzhou (CN)

(72) Inventor: Junsheng LIU, Guangzhou (CN)

(73) Assignee: Guangzhou China Star Optoelectronics Semiconductor Display Technology Co., LTd., Guangzhou (CN)

(21) Appl. No.: 19/253,953

(22) Filed: Jun. 29, 2025

(30) Foreign Application Priority Data
Apr. 30, 2025 (CN) 202510570604.8

(51) Int. Cl. G09G 3/36

(52) U.S. Cl. CPC G09G 3/3688; G09G 2320/0209; G09G 2320/0223; G09G 2320/0233; G09G 2330/021

(57) ABSTRACT

A display device and a driving method of the display device. The driving method of the display device includes: detecting by a source driving circuit whether a first power supply voltage from a power management chip drops; and adjusting a driving capability of at least one of display regions by the source driving circuit in response to a voltage drop of the first power supply voltage, to enable a driving capability of a first display region to be less than a driving capability of a second display region. The first display region is one of the plurality of display regions, the second display region is another one of the plurality of display regions, and the first display region is closer to the source driving circuit than the second display region.

### CROSS-REFERENCE TO RELATED APPLICATIONS

This application claims priority to Chinese Patent Application No. 202510570604.8 filed on Apr. 30, 2025, the entire contents of which are incorporated herein by reference.

### TECHNICAL FIELD

The present disclosure relates to the field of display technologies, especially to a display device and a driving method of the display device.

### BACKGROUND

When the active area (AA) of the display panel is under heavy load, and there are large shifts in grayscale values on the display screen, such as transitioning from a grayscale value of 255 (white) to 0 (black), the power supply voltage experiences a notable draw.

### SUMMARY

In a first aspect, the embodiments of the application provide a driving method of a display device. The display device includes a power management chip, a source driving circuit connected to the power management chip, and a display panel connected to the source driving circuit. The display panel includes a plurality of display regions. The driving method includes: detecting by the source driving circuit whether a first power supply voltage from the power management chip drops; and adjusting a driving capability of at least one of the display regions by the source driving circuit in response to a voltage drop of the first power supply voltage, to enable a driving capability of a first display region to be less than a driving capability of a second display region. The first display region is one of the plurality of display regions, the second display region is another one of the plurality of display regions, and the first display region is closer to the source driving circuit than the second display region.

In a second aspect, the embodiments of the present disclosure provide a display device. The display device includes a power management chip, a source driving circuit connected to the power management chip, and a display panel connected to the source driving circuit. The display panel includes a plurality of display regions. The source driving circuit is configured to perform the driving method of the display device in the first aspect.

### BRIEF DESCRIPTION OF THE DRAWINGS

FIG. 1 is a schematic view of a display device provided by an embodiment of the present disclosure.

FIG. 2 is a flowchart of a driving method of a display device provided by an embodiment of the present disclosure.

FIG. 3 is a schematic diagram of a first mapping relationship provided by an embodiment of the present disclosure.

FIG. 4 is a schematic diagram of a second mapping relationship provided by an embodiment of the present disclosure.

FIG. 5 is a schematic diagram of an image improvement effect provided by an embodiment of the present disclosure.

FIG. 6 is another schematic diagram of an image improvement effect provided by an embodiment of the present disclosure.

### DETAILED DESCRIPTION

The technical solutions in the embodiments of the present disclosure will be described hereinafter with reference to the accompanying drawings. The technical solutions described are only used to explain and illustrate the ideas of the present disclosure and should not be regarded as limiting the protection scope of the present disclosure.

In addition, “a plurality of” in the embodiments of the present disclosure refers to two or more. The terms “first” and “second” in the embodiments of the present application are used to distinguish different technical features and do not indicate any order, quantity, or importance.

The various embodiments provided by the present disclosure are similar, and features in different embodiments can be combined with each other.

The order of description of the following embodiments is not intended to limit the preferred order of the embodiments.

When the active area (AA) of the display panel is under heavy load, and there are large shifts in grayscale values on the display screen, such as transitioning from a grayscale value of 255 (white) to 0 (black), the power supply voltage experiences a notable draw. Under such circumstances, the near-end voltage and far-end voltage of the array substrate wiring (Wire On Array, WOA) may undergo a voltage drop, causing a drop in the output voltage of the same source driving circuit (Source Driver Integrated Circuit, Source IC or Driver IC), which is liable to result in horizontal crosstalk (H-Crosstalk). The horizontal crosstalk appears as horizontal interference stripes or inconsistent brightness in the display screen, which affects the display performance.

To address the aforementioned shortcomings, the present disclosure provides a display device and a driving method of the display device, which can mitigate or avoid horizontal crosstalk and enhance display performance.

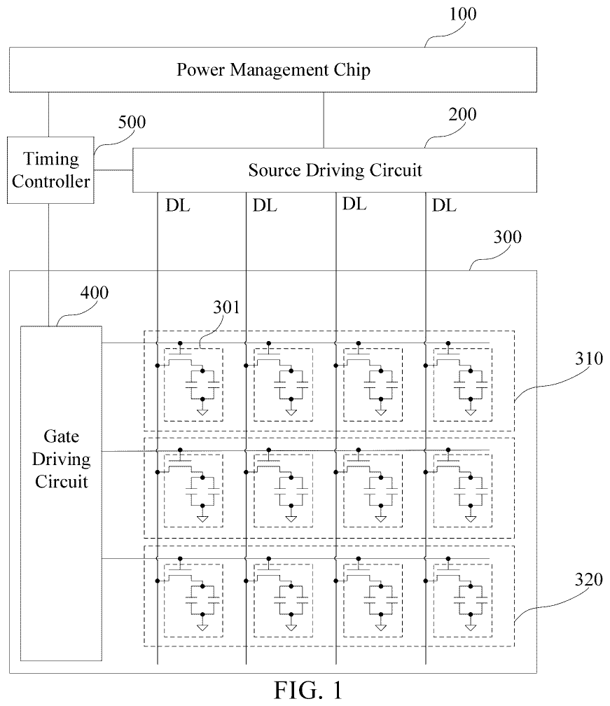

Please refer to FIG. 1, which is a schematic view of a display device provided by an embodiment of the present disclosure. The display device includes a liquid crystal display (LCD) device. It should be noted that this does not limit the scope of the present disclosure. In practical applications, the display device may include any one of an active-matrix organic light emitting diode (AMOLED) display device, a micro light emitting diode (Micro LED) display device, and a miniature light emitting diode (Mini LED) display device.

As shown in FIG. 1, the display device includes a power management chip 100, a source driving circuit 200 connected to the power management chip 100, and a display panel 300 connected to the source driving circuit 200. The source driving circuit 200 may be integrated into the display panel 300 or may be independent of the display panel 300, which is not limited to the embodiment of the present application. Additionally, the display device may include one or more source driving circuits 200. FIG. 1 takes one source driving circuit 200 as an example, which does not constitute a limitation of the present disclosure. As shown in FIG. 1, the display panel 300 includes a plurality of pixel units 301, and each pixel unit 301 may be connected to the source driving circuit 200 through a data line DL, so that the source driving circuit 200 may drive the pixel units 301 through the data line DL, enabling the display panel 300 to render images.

Furthermore, as shown in FIG. 1, the display device may further include a gate driving circuit 400 and a timing controller 500. The gate driving circuit 400 is integrated into the display panel 300. The timing controller 500 is connected to the source driving circuit 200 and the power management chip 100. The power management chip 100 may supply power to the timing controller 500 and the source driving circuit 200, etc., as well as provide gamma voltage to the source driving circuit 200, etc. The gate driving circuit 400 may provide a scanning signal to the pixel unit 301 of the display panel 300 in response to the timing signal from the timing controller 500 to control the switching state of the pixel unit 301. Moreover, the source driving circuit 200 may control the brightness and color of the pixel unit 301 in the display panel 300 in response to the data signal from the timing controller 500.

In the embodiments of the present disclosure, the display panel 300 may include a plurality of display regions. As shown in FIG. 1, the display panel 300 includes a plurality of display regions, and the display regions include a first display region 310 and a second display region 320. The first display region 310 is the at least one of the display regions close to the source driving circuit 200, and the second display region 320 is another one of the display regions away from the source driving circuit 200. The display panel 300 may only include the first display region 310 and the second display region 320, that is, the plurality of display regions may be two adjacent display regions, namely the first display region 310 and the second display region 320. Alternatively, the display panel 300 may further include additional display regions located between the first display region 310 and the second display region 320, that is, the display panel 300 may be divided into more than two display regions. The embodiments of the present disclosure do not limit the division method, shape, and size of the display region. In actual applications, they can be flexibly set according to needs. For example, the display panel 300 may be divided into a plurality of display regions based on the distances between different positions of the display panel 300 and the source driving circuit 200. The shapes of the display regions may be rectangular, polygonal, elliptical, etc. The sizes of different display regions may be the same or different, and the areas of the display regions may be the same or different.

The source driving circuit 200 is configured to detect whether the first power supply voltage from the power management chip 100 drops. The source driving circuit 200 adjusts the driving capability of at least one of the display regions in response to a voltage drop of the first power supply voltage, to enable the driving capability of the first display region 310 to be less than the driving capability of the second display region 320. The display panel 300 is connected to the source driving circuit 200 through a plurality of data lines DL. That the source driving circuit 200 adjusts the driving capability of at least one of the display regions of the display panel 300, refers to adjusting the driving capability of the data line DL within at least one of the display regions. The same data line DL may be divided into different display regions. In the embodiments of the present disclosure, adjusting the driving capability of the data line DL in at least one of the display regions can enable the same data line DL to have different driving capabilities in different display regions. For example, the driving capability of a portion of one data line DL close to the source driving circuit 200 may be adjusted to be less than the driving capability of another portion of the same data line DL away from the source driving circuit 200.

Since the display data is output from the source driving circuit 200, based on the principle of signal attenuation, the signal attenuation in the first display region 310 close to the source driving circuit 200 is small, and the signal attenuation in the second display region 320 away from the source driving circuit 200 is large. In the embodiments of the present disclosure, by adjusting the driving capability of at least one of the display regions, the driving capability of the first display region 310 may be less than the driving capability of the second display region 320, thereby making the signals output by the same path more stable and reducing or avoiding the sudden phenomenon of data output signals.

In some embodiments, the source driving circuit 200 may be further configured to reduce the driving capability of the first display region 310. In some embodiments, the source driving may be further configured to increase the driving capability of the second display region 320.

In some embodiments, the source driving circuit 200 is further configured to adjust the driving capability of the display region based on the distance between at least one display region and the source driving circuit 200. The driving capability of the display region is positively correlated with the distance between the at least one display region and the source driving circuit 200.

In some embodiments, the source driving circuit 200 is further configured to adjust the driving capability of at least one display region based on the degree of the voltage drop of the first power supply voltage. The adjustment degree of the driving capability of the at least one display region is positively correlated with the degree of the voltage drop of the first power supply voltage.

In some embodiments, the source driving circuit 200 is further configured to determine an initial adjustment value of at least one display region based on the distance between the at least one display region and the source driving circuit 200, to determine a target adjustment value of the at least one display region based on the degree of the voltage drop of the first power supply voltage and the initial adjustment value of the at least one display region, and to adjust the driving capability of the display region based on the target adjustment value of the at least one display region.

In some embodiments, the source driving circuit 200 is further configured to determine a correction factor based on the degree of the voltage drop of the first power supply voltage, and to determine the target adjustment value of at least one display region based on the correction factor and the initial adjustment value of the at least one display region.

In some embodiments, the source driving circuit 200 is further configured to determine whether the first power supply voltage drops based on the first power supply voltage and a preset voltage threshold. When the first power supply voltage exceeds the preset voltage threshold, the source driving circuit 200 determines that the first power supply voltage drops.

In some embodiments, the first power supply voltage includes at least one of a positive analog power supply voltage and a negative analog power supply voltage.

In some embodiments, the preset voltage thresholds include a first voltage threshold and a second voltage threshold. The source driving circuit 200 is further configured to determine whether the first power supply voltage drops based on the positive analog power supply voltage and the first voltage threshold, and the negative analog power supply voltage and the second voltage threshold. When the positive analog power supply voltage is less than the first voltage threshold, or the negative analog power supply voltage is greater than the second voltage threshold, the source driving circuit 200 determines that the first power supply voltage drops.

For other descriptions about the voltage drop detection method of the first power supply voltage, the driving capability adjustment method of the display region, the execution steps of the source driving circuit 200 and beneficial effects thereof, please refer to the method implementation examples below, which will not be described here.

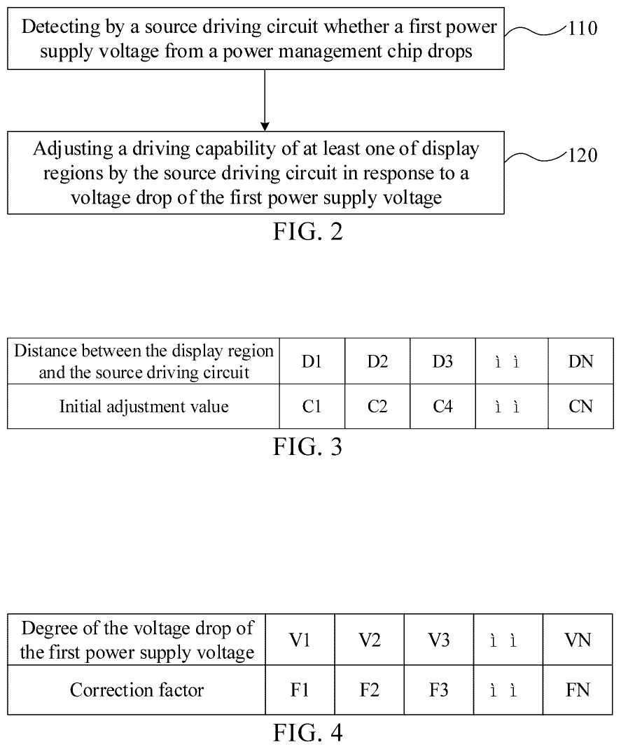

Please refer to FIG. 2, which is a flowchart of a driving method of a display device provided by an embodiment of the present disclosure. The display device may include a power management chip, a source driving circuit connected to the power management chip, and a display panel connected to the source driving circuit, and the display panel includes a plurality of display regions. The driving method of the display device may be applied to the source driving circuit. For example, the display device may be as shown in FIG. 1, and the driving method of the display device may be performed by the source driving circuit 200 in FIG. 1. As shown in FIG. 2, the driving method of the display device may include the following steps.

At step 110, the source driving circuit detects whether a first power supply voltage from the power management chip drops.

At step 120, the source driving circuit adjusts the driving capability of at least one of the display regions in the display panel in response to a voltage drop of the first power supply voltage.

The power management chip is connected to the source driving circuit, and the first power supply voltage output by the power management chip is configured to supply power to the source driving circuit. In some embodiments, the first power supply voltage includes at least one of the positive analog power supply voltage (Analog Voltage Drain, AVDD) and the negative analog power supply voltage (Analog Voltage Emitter, AVEE).

In step 110, the source driving circuit detects whether the first power supply voltage drops. The embodiments of the present disclosure do not limit the specific detection method for whether the first power supply voltage drops. For example, the first power supply voltage may be compared to the predefined voltage threshold to determine whether the first power supply voltage drops. Alternatively, the change amount of the first power supply voltage may be compared to a preset voltage difference threshold to determine whether the first power supply voltage drops.

In some embodiments, step 110 includes that the source driving circuit determines whether the first power supply voltage drops based on the first power supply voltage and the preset voltage threshold. When the first power supply voltage exceeds the preset voltage threshold, the source driving circuit determines that the first power supply voltage drops. When the first power supply voltage does not exceed the preset voltage threshold, the source driving circuit determines that the first power supply voltage does not drop. It should be understood that “exceeding” may refer to being greater than or less than, and “exceeding” has different meanings depending on the value ranges defined by the first power supply voltage and the preset voltage threshold. For example, if the first power supply voltage is the positive analog power supply voltage, the preset voltage threshold may be a positive value, and “exceeding” may mean that the positive analog power supply voltage is less than the preset voltage threshold. If the first power supply voltage is the negative analog power supply voltage, the preset voltage threshold may be a negative value, and “exceeding” may mean that the negative analog power supply voltage is greater than the preset voltage threshold.

Taking the first power supply voltage, which includes the positive analog supply voltage and the negative analog supply voltage, as an example, the preset voltage threshold includes a first voltage threshold and a second voltage threshold. Step 110 includes that the source driving circuit determines whether the first power supply voltage drops based on the positive analog supply voltage and the first voltage threshold, and the negative analog supply voltage and the second voltage threshold. The first voltage threshold may be a positive value, and the second voltage threshold may be a negative value. When the positive analog power supply voltage is less than the first voltage threshold, or the negative analog power supply voltage is greater than the second voltage threshold, the source driving circuit determines that the first power supply voltage drops. That is, if either the positive voltage or the negative analog power supply voltage exceeds the corresponding voltage threshold, it is considered that the first power supply voltage drops. The embodiments of the present disclosure do not limit the specific values of the first voltage threshold and the second voltage threshold. In practical applications, they may be flexibly set according to needs. For example, the first voltage threshold may be set to 5.5 V or 5 V, and the second voltage threshold may be set to −5.5 V or −5 V.

In step 120, the source driving circuit adjusts the driving capability of at least one of the display regions in the display panel in response to a voltage drop of the first power supply voltage. In the embodiments of the present disclosure, the display panel includes a first display region close to the source driving circuit and a second display region away from the source driving circuit. Under the circumstance where the first power supply voltage drops, the source driving circuit adjusts the driving capability of at least one of the display regions so that the driving capability of the first display region is less than that of the second display region.

In some embodiments, step 120 may include one of the following steps: reducing the driving capability by the source driving circuit in the first display region; and increasing the driving capability by the source driving circuit of the second display region. In practical applications, it is possible to only reduce the driving capability of the first display region, or only increase the driving capability of the second display region, or reduce the driving capability of the first display region while increasing the driving capability of the second display region. Based on the principle of signal attenuation, the first display region is close to the source driving circuit, resulting in less attenuation of data output in the first display region, and the second display region is far away from the source driving circuit, resulting in greater attenuation of data output in the second display region. To enable the data output of the same source driving circuit to be more stable, the driving capability of the first display region may be reduced, the driving capability of the second display region may be increased, or the driving capability of the first display region is reduced while the driving capability of the second display region is increased. By adjusting the driving capability of the first display region and the driving capability of the second display region, it is possible to enable the driving capability of the first display region to be less than the driving capability of the second display region, thereby compensating for the data output attenuation of the second display region and ensuring that the data output of the same source driving circuit remains more stable.

In some embodiments, step 120 includes that the source driving circuit adjusts the driving capability of the display region based on the distance between the display region and the source driving circuit. Based on the principle of signal attenuation, as the transmission distance increases on data communication lines, signal attenuation also intensifies. Therefore, when adjusting the driving capability of at least one of the display regions, the driving capability of the display region may be positively correlated with the distance between the display region and the source driving circuit. That is, the closer the display region is to the source driving circuit, the weaker the driving capability of the display region. The farther the display region is from the source driving circuit, the stronger the driving capability of the display region.

For example, the display panel includes a first display region close to the source driving circuit and a second display region far away from the source driving circuit. After adjusting the driving capability of at least one of the display regions, the driving capability of the first display region may be less than that of the second display region. Moreover, if the display panel further includes other display regions located between the first display region and the second display region, the driving capability of these other display regions may fall between the driving capability of the first display region and the driving capability of the second display region.

In some embodiments, step 120 includes that the source driving circuit adjusts the driving capability of the display region based on the degree of the voltage drop of the first power supply voltage. The degree of the voltage drop of the first power source refers to the degree of sudden change in the first power source voltage, such as the degree to which the first power source voltage decreases. The adjustment degree of the driving capability of the display region is positively correlated with the degree of the voltage drop of the first power supply voltage. That is, the less the voltage drop of the first power supply voltage, the less the adjustment degree of the source driving circuit for the driving capability of the display region, and the larger the voltage drop of the first power supply voltage, the greater the adjustment degree of the source driving circuit for the driving capability of the display region. In the case where the first power supply voltage includes a plurality of voltages, the degree of the voltage drop of the first power supply voltage may be the average value or the weighted average value of the degrees of the voltage drop of the plurality of voltages. For example, in the case where the first power supply voltage includes the positive analog power supply voltage and the negative analog power supply voltage, the degree of the voltage drop of the first power supply voltage may be the average value of the degree of the voltage drop of the positive analog power supply voltage and the degree of voltage drop of the negative analog power supply voltage.

The source driving circuit may adjust the driving capability of at least one of the display regions by combining a plurality of factors, such as the distance between at least one display region and the source driving circuit, as well as the degree of the voltage drop of the first power supply voltage. In some embodiments, the step 120 includes that the source driving circuit determines the initial adjustment value of at least one display region based on the distance between the at least one display region and the source driving circuit, the source driving circuit determines the target adjustment value of the at least one display region based on the degree of the voltage drop of the first power supply voltage and the initial adjustment value of the at least one display region, and the source driving circuit adjusts the driving capability of the display region based on the target adjustment value of the at least one display region. That the source driving circuit determines the target adjustment value of the display region based on the degree of the voltage drop of the first power supply voltage and the initial adjustment value of the at least one display region, includes that the source driving circuit determines a correction factor based on the degree of the voltage drop of the first power supply voltage, and the source driving circuit determines the target adjustment value of the display region based on the correction factor and the initial adjustment value of the at least one display region. For example, the source driving circuit may increase or reduce the correction factor based on the initial adjustment value to obtain the target adjustment value. Alternatively, the source driving circuit may use the product of the initial adjustment value and the correction factor as the target adjustment value.

In the embodiments of the present disclosure, a first mapping relationship and a second mapping relationship may be preset, where the first mapping relationship includes the mapping between the initial adjustment value and the distance between the display region and the source driving circuit, and the second mapping relationship includes the mapping relationship between the correction factor and the degree of the voltage drop of the first power supply voltage. The distance between the display region and the source driving circuit in the first mapping relationship may be a specific distance value or a range of distances. For each display region, after determining the distance between the display region and the source driving circuit, the corresponding initial adjustment value may be obtained from the first mapping relationship based on the distance. After determining the degree of the voltage drop of the first power supply voltage, the corresponding correction factor may be obtained from the second mapping relationship based on the degree of the voltage drop. Then, the target adjustment value for each display region may be determined based on the correction factor and the initial adjustment value of each display region. Illustratively, the first mapping relationship may be as shown in FIG. 3, and the second mapping relationship may be as shown in FIG. 4.

It should be understood that the embodiments of the present disclosure do not limit the specific methods of adjusting the driving capability, allowing flexible selection based on actual application needs. In some embodiments, the driving capability may be adjusted by adjusting the driving current, or by adjusting the circuit layout of the display region. For example, the driving capability may be adjusted by adjusting components such as the source driving circuit or the buffer, amplifier, resistor, capacitor, or inductor in the display panel.

In summary, in the technical solution provided by the embodiments of the present disclosure, the source driving circuit adjusts the driving capability of at least one of the display regions in the display panel when detecting a voltage drop of the first power supply voltage from the power management chip, so that the driving capability of the first display region close to the source driving circuit is less than that of the second display region far away from the source driving circuit. In the embodiments of the present disclosure, when the first power supply voltage drops, the source driving circuit adjusts the driving capability of at least one of the display regions in the display panel, which may enable the source driving circuit to output data to different display regions more stably, thereby mitigating or avoiding abrupt changes in the output signal of the source driving circuit, thereby mitigating or avoiding horizontal crosstalk and improving the display performance. Furthermore, the embodiments of the present disclosure may save debugging time and layout space for the display device, without increasing the cost of the display device, offering good applicability.

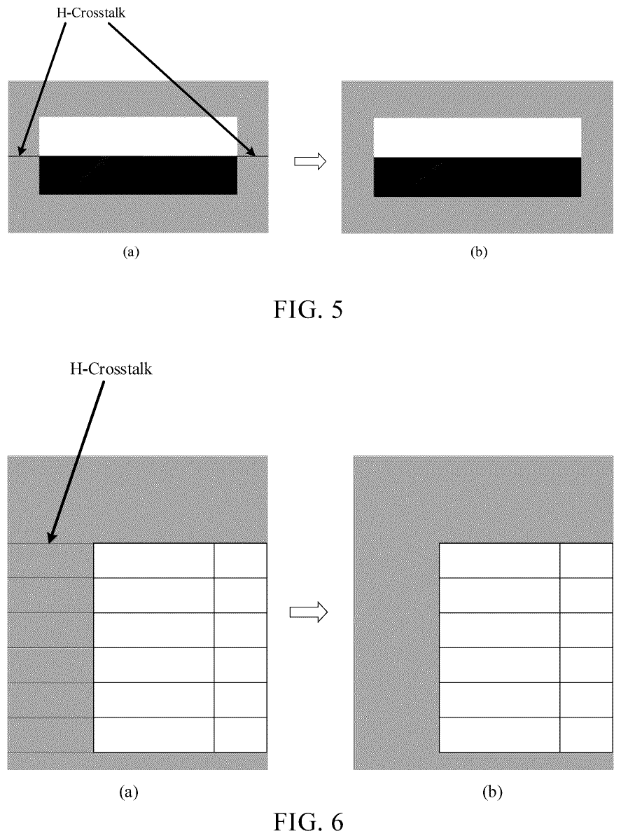

As shown in (a) of FIG. 5, under a gray background, the switching position between black and white regions is prone to horizontal crosstalk. Based on the technical solution provided by the embodiments of the present disclosure, when the source driving circuit detects a voltage drop of the first power supply voltage, the driving capability of at least one of the display regions is adjusted, the driving capability of the first display region close to the source driving circuit is reduced, and the driving capability of the second display region far away from the source driving circuit is increased. This adjustment effectively avoids horizontal crosstalk, as shown in (b) of FIG. 5.

As shown in (a) of FIG. 6, under a gray background, when dragging the table, horizontal crosstalk tends to occur at the edges of the table. Based on the technical solution provided by the embodiments of the present disclosure, when the source driving circuit detects a voltage drop of the first power supply voltage, the driving capability of at least one of the display regions is adjusted, the driving capability of the first display region close to the source driving circuit is reduced, and the driving capability of the second display region far away from the source driving circuit is increased. This adjustment effectively avoids horizontal crosstalk, as shown in (b) of FIG. 6.

In summary, in the display device and the driving method thereof provided by the embodiments of the present disclosure, the source driving circuit adjusts the driving capability of at least one of the display regions in the display panel when detecting a voltage drop of the first power supply voltage from the power management chip, so that the driving capability of the first display region close to the source driving circuit is less than that of the second display region far away from the source driving circuit. In the embodiments of the present disclosure, when the first power supply voltage drops, the source driving circuit adjusts the driving capability of at least one of the display regions in the display panel, which may enable the source driving circuit to output data to different display regions more stably, thereby mitigating or avoiding abrupt changes in the output signal of the source driving circuit, thereby mitigating or avoiding horizontal crosstalk and improving the display performance. Furthermore, the embodiments of the present disclosure may save debugging time and layout space for the display device, without increasing the cost of the display device, offering good applicability.

The display device and the driving method thereof provided by the embodiments of the present disclosure have been described in detail above, and the principles and embodiments of the present disclosure have been described herein by applying specific examples, and the description of the above embodiments is only for helping to understand the technical solutions and core ideas of the present disclosure. In addition, those skilled in the art may change the specific embodiments and the scope of this application according to the ideas of the present disclosure, and in summary, the contents of the present specification should not be construed as limiting the present disclosure.

1. A driving method of a display device, wherein the display device comprises a power management chip, a source driving circuit connected to the power management chip, and a display panel connected to the source driving circuit, and the display panel comprises a plurality of display regions; wherein the driving method comprises:
detecting by the source driving circuit whether a first power supply voltage from the power management chip drops, wherein determining by the source driving circuit whether the first power supply voltage drops based on the first power supply voltage and a preset voltage threshold, the preset voltage threshold comprises a first voltage threshold and a second voltage threshold, comprising:
determining by the source driving circuit whether the first power supply voltage drops, based on a comparison between the positive analog power supply voltage and the first voltage threshold, and a comparison between the negative analog power supply voltage and the second voltage threshold;
wherein, in response to the positive analog power supply voltage being less than the first voltage threshold, or to the negative analog power supply voltage greater than the second voltage threshold, the source driving circuit determines that the first power supply voltage drops; and
adjusting a driving capability of at least one of the display regions by the source driving circuit in response to a voltage drop of the first power supply voltage, to enable a driving capability of a first display region to be less than a driving capability of a second display region; wherein the first display region is one of the plurality of display regions, the second display region is another one of the plurality of display regions, and the first display region is closer to the source driving circuit than the second display region.

2. The driving method of the display device of claim 1, wherein the adjusting the driving capability of at least one of the display regions by the source driving circuit comprises at least one of the following steps:
reducing the driving capability of the first display region by the source driving circuit; and
increasing the driving capability of the second display region by the source driving circuit.

3. The driving method of the display device of claim 1, wherein the adjusting the driving capability of at least one of the display regions by the source driving circuit comprises:
adjusting the driving capability of the at least one of the display regions by the source driving circuit based on a distance between the at least one of the display regions and the source driving circuit;
wherein the driving capability of the at least one of the display regions is positively correlated with the distance between the at least one of the display regions and the source driving circuit.

4. The driving method of the display device of claim 1, wherein the adjusting the driving capability of at least one of the display regions by the source driving circuit comprises:
adjusting the driving capability of the at least one of the display regions by the source driving circuit based on a degree of the voltage drop of the first power supply voltage;
wherein an adjustment degree of the driving capability of the at least one of the display regions is positively correlated with the degree of the voltage drop of the first power supply voltage.

5. The driving method of the display device of claim 1, wherein the adjusting the driving capability of at least one of the display regions by the source driving circuit comprises:
determining an initial adjustment value of the at least one of the display regions by the source driving circuit based on a distance between the at least one of the display regions and the source driving circuit;
determining a target adjustment value of the at least one of the display regions by the source driving circuit based on a degree of the voltage drop of the first power supply voltage and the initial adjustment value of the at least one of the display regions; and
adjusting the driving capability of the at least one of the display regions by the source driving circuit based on the target adjustment value of the at least one of the display regions.

6. The driving method of the display device of claim 5, wherein the determining the target adjustment value of the at least one of the display regions by the source driving circuit based on the degree of the voltage drop of the first power supply voltage and the initial adjustment value of the at least one of the display regions comprises:
determining a correction factor based on the degree of the voltage drop of the first power supply voltage by the source driving circuit;
determining the target adjustment value of the at least one of the display regions by the source driving circuit based on the correction factor and the initial adjustment value of the at least one of the display regions.

7. The driving method of the display device of claim 1, wherein the detecting by the source driving circuit whether the first power supply voltage from the power management chip drops comprises:
determining by the source driving circuit whether the first power supply voltage drops based on the first power supply voltage and a preset voltage threshold;
wherein the source driving circuit determines that the first power supply voltage drops in response to the first power supply voltage exceeding the preset voltage threshold.

8. The driving method of the display device of claim 7, wherein the first power supply voltage comprises at least one of a positive analog power supply voltage and a negative analog power supply voltage.

9. (canceled)

10. A display device comprising a power management chip, a source driving circuit connected to the power management chip, and a display panel connected to the source driving circuit, the display panel comprising a plurality of display regions; wherein the source driving circuit is configured to perform a driving method of the display device, and the driving method comprises:
detecting by the source driving circuit whether a first power supply voltage from the power management chip drops, wherein determining by the source driving circuit whether the first power supply voltage drops based on the first power supply voltage and a preset voltage threshold, the preset voltage threshold comprises a first voltage threshold and a second voltage threshold, comprising:
determining by the source driving circuit whether the first power supply voltage drops, based on a comparison between the positive analog power supply voltage and the first voltage threshold, and a comparison between the negative analog power supply voltage and the second voltage threshold;
wherein, in response to the positive analog power supply voltage being less than the first voltage threshold, or to the negative analog power supply voltage greater than the second voltage threshold, the source driving circuit determines that the first power supply voltage drops; and
adjusting a driving capability of at least one of the display regions by the source driving circuit in response to a voltage drop of the first power supply voltage, to enable a driving capability of a first display region to be less than a driving capability of a second display region; wherein the first display region is one of the plurality of display regions, the second display region is another one of the plurality of display regions, and the first display region is closer to the source driving circuit than the second display region.

11. The display device of claim 10, wherein the adjusting the driving capability of at least one of the display regions by the source driving circuit comprises at least one of the following steps:
reducing the driving capability of the first display region by the source driving circuit; and
increasing the driving capability of the second display region by the source driving circuit.

12. The display device of claim 10, wherein the adjusting the driving capability of at least one of the display regions by the source driving circuit comprises:
adjusting the driving capability of the at least one of the display regions by the source driving circuit based on a distance between the at least one of the display regions and the source driving circuit;
wherein the driving capability of the at least one of the display regions is positively correlated with the distance between the at least one of the display regions and the source driving circuit.

13. The display device of claim 10, wherein the adjusting the driving capability of at least one of the display regions by the source driving circuit comprises:
adjusting the driving capability of the at least one of the display regions by the source driving circuit based on a degree of the voltage drop of the first power supply voltage;
wherein an adjustment degree of the driving capability of the at least one of the display regions is positively correlated with the degree of the voltage drop of the first power supply voltage.

14. The display device of claim 10, wherein the adjusting the driving capability of at least one of the display regions by the source driving circuit comprises:
determining an initial adjustment value of the at least one of the display regions by the source driving circuit based on a distance between the at least one of the display regions and the source driving circuit;
determining a target adjustment value of the at least one of the display regions by the source driving circuit based on a degree of the voltage drop of the first power supply voltage and the initial adjustment value of the at least one of the display regions; and
adjusting the driving capability of the at least one of the display regions by the source driving circuit based on the target adjustment value of the at least one of the display regions.

15. The display device of claim 14, wherein the determining the target adjustment value of the at least one of the display regions by the source driving circuit based on the degree of the voltage drop of the first power supply voltage and the initial adjustment value of the at least one of the display regions comprises:
determining a correction factor based on the degree of the voltage drop of the first power supply voltage by the source driving circuit; and
determining the target adjustment value of the at least one of the display regions by the source driving circuit based on the correction factor and the initial adjustment value of the at least one of the display regions.

16. The display device of claim 10, wherein the detecting by the source driving circuit whether the first power supply voltage from the power management chip drops, comprises:
determining by the source driving circuit whether the first power supply voltage drops based on the first power supply voltage and a preset voltage threshold;
wherein the source driving circuit determines that the first power supply voltage drops in response to the first power supply voltage exceeding the preset voltage threshold.

17. The display device of claim 16, wherein the first power supply voltage comprises at least one of a positive analog power supply voltage and a negative analog power supply voltage.

18. (canceled)
